(19) United States
(12) Patent Application Publication
(10) Pub. No.: US 2026/0340997 A1
(43) Pub. Date: Oct. 29, 2026

(54) METHOD FOR TRAINING A HARMONIZATION NETWORK AND DEVICE FOR TRAINING A HARMONIZATION NETWORK

(71) Applicant: SEOUL NATIONAL UNIVERSITY R&DB FOUNDATION, Seoul (KR)

(72) Inventors: Minjun KIM, Seoul (KR); Jongho LEE, Seoul (KR)

(21) Appl. No.: 19/299,712

(22) Filed: Aug. 14, 2025

(30) Foreign Application Priority Data
Apr. 25, 2025 (KR) 10-2025-0054502

(51) Int. Cl. G06V 10/774; G06V 10/72; G06V 10/82

(52) U.S. Cl. CPC G06V 10/774; G06V 10/72; G06V 10/82; G06V 2201/03

(57) ABSTRACT

A method for training a harmonization network is disclosed. The method comprises: perturbing each of a set of source data belonging to a source domain to generate a plurality of perturbed data; inputting each of the perturbed data into a given target model to obtain a plurality of output data; selecting a subset of the perturbed data as pseudo-target data based on errors between a set of label data provided for the source data and the corresponding output data; and training a harmonization network such that, when source data corresponding to the pseudo-target data are input into the harmonization network, the error between the output of the harmonization network and the pseudo-target data is reduced.

### CROSS-REFERENCE TO RELATED APPLICATIONS

This application claims priority to Korean Patent Application No. 10-2025-0054502 filed on Apr. 25, 2025, and all the benefits accruing therefrom under 35 U.S.C. § 119, the contents of which are incorporated by reference in their entirety.

### BACKGROUND

The present invention relates to a technique for training a harmonization network using a computing device and transforming data belonging to a source domain into data suitable for a target domain using the trained harmonization network.

The concept of a harmonization network is primarily used to reduce discrepancies between different domains and may be applied to address issues related to domain adaptation, style transfer, or multi-domain learning, particularly in the fields of computer vision and deep learning. Specifically, a harmonization network compensates for feature mismatches between different domains. The concept can also be applied in the field of medical imaging. For example, a harmonization network can be used to process medical image data acquired from different imaging devices in a consistent manner.

A domain refers to a scope or region that defines the characteristics or distribution of data. For instance, the difference between a first domain and a second domain may indicate that the data from each domain have different distributions in the feature space. Specifically, a first medical device having unique characteristics and image data acquired by the first device may be defined as belonging to a first domain. Likewise, a second medical device having its own unique characteristics and image data acquired by the second device may be defined as belonging to a second domain. When the characteristics of the first and second devices differ, the feature space distributions of the respective image data will also differ. Therefore, in such a case, the first domain and the second domain may be regarded as different domains.

Assume that a second software module has been verified to operate effectively when provided with image data from the second domain. This second software module may be optimized for the second domain. Accordingly, when image data from the first domain are input into the second software module, the module may fail to function effectively. To solve this problem, when the image data from the first domain are input into a properly designed harmonization network, the network outputs harmonized image data mapped into the feature space of the second domain. If the harmonized image data are then input into the second software module instead of the original image data, the second software module may operate effectively on the harmonized data.

As such, providing a harmonization network capable of accurately mapping data from the first domain (i.e., the source domain) into the feature space of the second domain (i.e., the target domain) is a critical technical challenge.

The above explanation of the concepts of harmonization networks and domains is provided merely to aid in understanding the present invention, and the invention is not necessarily limited thereto.

### SUMMARY

The present invention aims to provide a novel and effective technique for generating a harmonization network that maps data belonging to a source domain into the feature space of a target domain.

According to one aspect of the present invention, a harmonization network training method is provided, the method comprising:

a step in which a computing device perturbs each of a set of source data belonging to a source domain to generate a plurality of perturbed data; a step in which the computing device inputs the plurality of perturbed data into a given target model to obtain a plurality of output data; a step in which the computing device selects some of the plurality of perturbed data as pseudo-target data based on errors between a set of label data corresponding to the set of source data and the plurality of output data; and a training step in which the computing device trains a predetermined harmonization network such that the error between the output generated by the harmonization network and the corresponding pseudo-target data, when the source data paired with the pseudo-target data is input into the harmonization network, is reduced.

The harmonization network training method may further comprise, after the training step, a second-stage training step in which the computing device additionally trains the harmonization network using a second set of source data belonging to the source domain and a second set of label data corresponding thereto.

In this case, at least a portion of the second set of source data may be included in the set of source data.

Conversely, at least a portion of the set of source data may be included in the second set of source data.

Alternatively, the set of source data and the second set of source data may be mutually exclusive.

The second-stage training step may include: a step in which the computing device inputs first source data from the second set into the harmonization network to output first harmonized data; a step in which the computing device inputs the first harmonized data into the target model to output first output data; and a step in which the computing device trains the harmonization network to reduce the error between the first output data and the first label data corresponding to the first source data.

Alternatively, the harmonization network training method may further include: a step in which the computing device inputs the second set of source data into the harmonization network to output a second set of harmonized data; a step in which the computing device inputs the second set of harmonized data into the target model to output a second set of output data; and a step in which the computing device trains the harmonization network to reduce the error between the second set of output data and the second set of label data corresponding to the second set of source data.

The harmonization network training method may further comprise: a step in which the computing device inputs a single source data from the source domain into the trained harmonization network to generate a single harmonized data; and a step in which the computing device inputs the harmonized data into the target model to obtain a single output data.

The target model may be a model trained on data belonging to the target domain, and the source domain and the target domain may be different domains.

The data belonging to the source domain may be data generated by a first electronic device, and the data belonging to the target domain may be data generated by a second electronic device, wherein the first and second electronic devices may be different devices.

The first electronic device may be a first MRI scanner, and the second electronic device may be a second MRI scanner.

Alternatively, the first electronic device may be a first X-ray device, and the second electronic device may be a second X-ray device.

Alternatively, the first electronic device may be a first CT device, and the second electronic device may be a second CT device.

Each of the harmonized data, source data, perturbed data, and input data may be in the form of image data.

The selection step may include: a step in which the computing device identifies the source data used to generate each output data among the plurality of output data, and the label data corresponding to the identified source data, to form a pair of the output data and the corresponding label data; a step in which the computing device calculates the error between each of the output data and its paired label data (n=1, . . . , N; where N is the total number of output data); a step in which the computing device selects M errors from among the N calculated errors (where M<N); and a step in which the computing device selects M perturbed data corresponding to the selected M errors as the pseudo-target data.

The maximum value among the M selected errors may be less than or equal to the minimum value among the remaining (N-M) unselected errors.

The source data may be image data.

The perturbation may be a randomly determined perturbation.

At least one of the harmonized data, source data, perturbed data, and input data may be image data that exhibits differences depending on the image acquisition device used to generate it, the acquisition environment, or the post-processing method performed to generate the image.

The algorithm executed by the computing device to perform the perturbation may include one or more of: contrast adjustment, blurring, and noise addition applied to the source data; image filtering algorithms; image processing algorithms; and algorithms utilizing AI models.

The source data may be MR images or X-ray images.

The label data and the output data may both be in the form of image data, or both may be in formats other than image data.

The target model may be a model whose transformation relationship between input and output is fixed and cannot be modified.

At least a portion of the second set of source data may be included in the first set of source data, or vice versa, or the two sets may be mutually exclusive.

The perturbation may be a randomly determined perturbation.

At least one of the harmonized data, source data, perturbed data, and input data may be image data that exhibits variation depending on the imaging device, the acquisition environment, or the post-processing method applied during image generation.

According to another aspect of the present invention, a harmonization network training method may include a first-stage training step comprising: a step of generating N perturbed images by applying perturbations to each of K source images belonging to a source domain, where K and N are natural numbers; a step of inputting each of the N perturbed images into a given target model to obtain N output data respectively corresponding to the N perturbed images from the target model; a step of selecting a subset of the N perturbed images as pseudo-target images based on errors between K label data, which are pre-prepared and respectively matched to the K source images, and the N output data; and a training step of training a harmonization network such that the error between an output image generated by the harmonization network and the corresponding pseudo-target image is reduced when the source image corresponding to the pseudo-target image is input into the harmonization network.

The harmonization network training method may further comprise, after the first-stage training step, a second-stage training step of additionally training the harmonization network using a second set of source images belonging to the source domain and a second set of label images corresponding to the second set of source images.

The second-stage training step may include: a step of inputting a first source image from the second set of source images into the harmonization network to output a first harmonized image; a step of inputting the first harmonized image into the target model to output first output data corresponding to the first harmonized image from the target model; and a step of training the harmonization network to reduce an error between the first output data and first label data provided for the first source image.

In this case, the target model may be a model trained using images belonging to the target domain.

After the second-stage training step, the first-stage training step may be repeatedly executed.

The selection of the number of source images and the number of perturbed images used in the first-stage training step executed before the second-stage training step, and the selection of the number of source images and the number of perturbed images used in the first-stage training step executed after the second-stage training step, may be performed independently of each other.

According to another aspect of the present invention, a harmonization network training method is provided, in which a harmonization network is trained to generate harmonized data, which are to be input into a predetermined target model, from source data belonging to a source domain. The harmonization network training method may include a second-stage training step of additionally training the harmonization network using a second set of source data belonging to the source domain and a second set of label data corresponding to the second set of source data. The second-stage training step may include: inputting a first source data from the second set into the harmonization network to output first harmonized data; inputting the first harmonized data into the target model to output first output data; and training the harmonization network to reduce the error between the first label data and the first output data.

According to another aspect of the present invention, a harmonization network training method is provided, in which a harmonization network is trained to generate harmonized data, which are to be input into a predetermined target model, from source data belonging to a source domain. The harmonization network training method may include: inputting a second set of source data belonging to the source domain into the harmonization network to output a second set of harmonized data; inputting the second set of harmonized data into the target model to output a second set of output data; and training the harmonization network to reduce the error between the second set of label data corresponding to the second set of source data and the second set of output data.

According to another aspect of the present invention, a non-transitory storage medium is provided, in which a set of machine-readable instructions is stored. When executed by a computing device, the instructions cause the computing device to: perturb each of a set of source data to generate a plurality of perturbed data; input the perturbed data into a predetermined target model to obtain a plurality of output data; select a subset of the perturbed data as pseudo-target data based on errors between the label data corresponding to the set of source data and the output data; and train a harmonization network such that the error between the output of the harmonization network and the pseudo-target data is reduced when the source data corresponding to the pseudo-target data are input into the harmonization network.

The set of instructions may include instructions for performing the perturbation, instructions for calculating the errors, instructions for implementing the harmonization network functionality, and instructions for performing the training.

The set of instructions may further include instructions for implementing the functionality of the target model.

According to another aspect of the present invention, a harmonization network training method is provided, in which a harmonization network is trained using a second set of source images belonging to a source domain and a second set of label images corresponding to the second set of source images. The method may include a second-stage training step comprising: inputting a first source image from the second set into the harmonization network to output a first harmonized image; inputting the first harmonized image into a predetermined target model to obtain first output data; and training the harmonization network to reduce the error between the first label data corresponding to the first source image and the first output data.

The harmonization network training method may further include, after the second-stage training step, a first-stage training step comprising: generating N perturbed images by applying perturbations to each of K source images belonging to the source domain (where K and N are natural numbers); inputting each of the N perturbed images into the target model to obtain N output data respectively corresponding to the perturbed images; selecting a subset of the perturbed images as pseudo-target images based on errors between K label data, each of which is pre-matched to one of the K source images, and the N output data; and training the harmonization network such that the error between an output image of the harmonization network and the corresponding pseudo-target image is reduced when the source image corresponding to the pseudo-target image is input into the harmonization network.

The second-stage training step may be repeatedly executed after the first-stage training step.

According to the present invention, a novel and effective technique is provided for generating a harmonization network that maps data belonging to a source domain into the feature space of a target domain.

### BRIEF DESCRIPTION OF THE DRAWINGS

FIG. 1A shows a process of selecting training data used for the first-stage training, and FIG. 1B illustrates a process of training the harmonization network 4 using the selected training data.

FIG. 2A is a diagram exemplifying the concepts of source data 10, perturbed data 20, output data 30, and label data 40 used during the selection process of training data as presented in FIG. 1A and FIG. 1B.

FIG. 2B is a diagram illustrating the concept of selecting a portion of the perturbed data 20 shown in FIG. 2A as pseudo-target data 50.

FIG. 3 is a diagram showing training data consisting of pairs of the pseudo-target data 50 selected in FIG. 2B and the respective source data 10 paired therewith.

FIG. 4 is a diagram illustrating a framework for second-stage training of a harmonization network training method according to an embodiment of the present invention.

FIG. 5A and FIG. 5B are reconstructed version of the framework in FIG. 1A and FIG. 1B based on the case where the source data 10, perturbed data 20, output data 30, label data 40, and pseudo-target data 50 are all in the form of images.

FIG. 6 is a reconstructed version of the framework in FIG. 4 based on the case where the source data 60, harmonized data 70, output data 80, and label data 90 are all in the form of images.

FIG. 7 is a flowchart illustrating the harmonization network training method according to an embodiment of the present invention.

FIG. 8A is a flowchart showing sub-steps constituting the second-stage training step according to one embodiment of the present invention.

FIG. 8B is a flowchart showing sub-steps constituting the second-stage training step according to another embodiment of the present invention.

FIG. 9 is a flowchart illustrating another embodiment of the harmonization network training method according to the present invention.

FIG. 10 is a flowchart illustrating a method of using the target model by employing a harmonization network trained according to one embodiment of the present invention.

FIG. 11 is a detailed flowchart of the step of selecting pseudo-target data 50 in FIG. 7.

FIG. 12 is a diagram illustrating a computing device provided according to an embodiment of the present invention.

### DETAILED DESCRIPTION OF EMBODIMENTS

Hereinafter, embodiments of the present invention will be described with reference to the accompanying drawings. However, the present invention is not limited to the embodiments described in this specification and may be implemented in various other forms. The terminology used herein is for the purpose of describing the embodiments and is not intended to limit the scope of the invention. Furthermore, the singular forms used below are intended to include the plural forms as well, unless the context clearly dictates otherwise.

### First-Stage Training of Harmonization Network

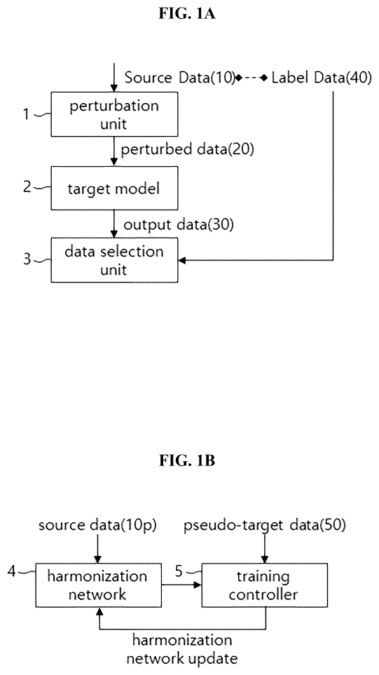

FIG. 1A and FIG. 1B are diagrams illustrating a framework for first-stage training of a harmonization network training method according to an embodiment of the present invention.

FIG. 1A shows a process of selecting training data used for the first-stage training, and FIG. 1B illustrates a process of training the harmonization network 4 using the selected training data.

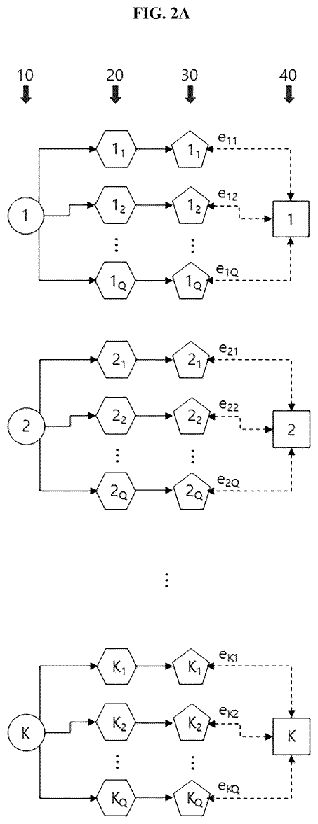

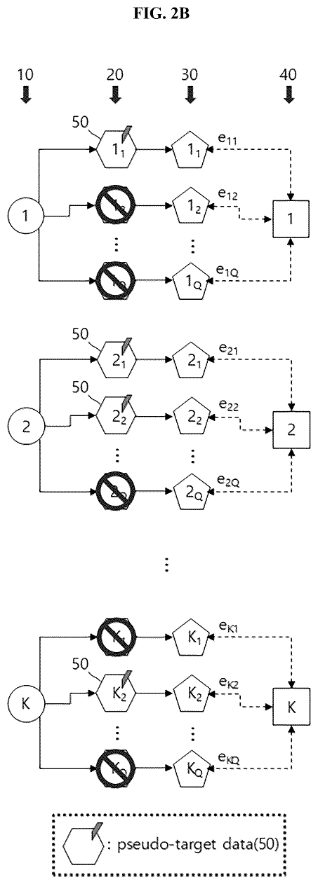

FIG. 2A is a diagram illustrating the concepts of source data 10, perturbed data 20, output data 30, and label data 40 used in the training data selection process shown in FIG. 1A.

FIG. 2B is a diagram illustrating the concept of selecting some of the perturbed data 20 shown in FIG. 2A as pseudo-target data 50.

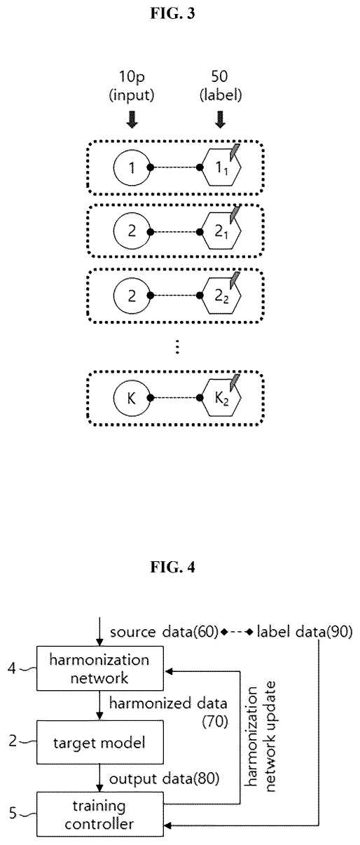

FIG. 3 is a diagram showing training data composed of pairs of pseudo-target data 50 selected in FIG. 2B and the respective paired source data. In this case, the paired source data 10p are used as input data for training the harmonization network 4, and the selected pseudo-target data 50 may be used as labels provided for the respective paired source data 10p.

Hereinafter, the method for first-stage training will be described with reference to FIGS. 1, 2a, 2b, and 3 collectively.

The method for first-stage training may be executed by a computing device reading and executing a program including a set of instructions from memory.

The memory may be a non-transitory storage medium or a volatile memory medium accessible by the computing device.

The set of instructions may include: a first set of instructions for implementing the functionality of a perturbation unit 1, a second set of instructions for implementing the functionality of a target model 2, a third set of instructions for implementing the functionality of a data selection unit 3, a fourth set of instructions for implementing the functionality of a harmonization network 4, a fifth set of instructions for implementing the functionality of a training controller 5 that trains the harmonization network 4, and a sixth set of instructions for scheduling the execution of the first through fifth sets of instructions.

In one embodiment, if the perturbation performed by the perturbation unit 1 is probabilistic random perturbation, the perturbation unit 1 may also be referred to as a random perturbation unit 1.

In an embodiment of the present invention, the term “perturbation” may refer to any possible operation that modifies the original data subject to perturbation. The transformation applied to each element of the data may be executed in a predefined or random manner. The format of the perturbed data may be the same as that of the original data.

The perturbation unit 1 may perform a function of generating and outputting N perturbed data 20 by perturbing each of K source data 10 belonging to the source domain. Here, K is a natural number equal to or greater than 1, and N may be a natural number greater than K.

In FIGS. 2A, 2B, and 3, the source data 10 are represented by circular icons, the perturbed data 20 are represented by hexagonal icons, the output data 30 described below are represented by pentagonal icons, and the label data 40 are represented by rectangular icons.

In this case, a single source data 10 may be independently perturbed multiple times to generate a plurality of perturbed data 20 from the single source data 10.

For example, in FIG. 2A, each of the pre-prepared K source data 10 is independently perturbed Q times to generate Q perturbed data 20 from each source data 10.

As the number of source data 10 subjected to perturbation increases, the number of perturbed data generated by the perturbation unit 1 may also increase. For instance, if Q perturbed data are generated from a single source data, then a total of K×Q perturbed data may be generated from K source data.

In one embodiment, the source domain may be defined by an image that is generated by a predetermined first device through detecting or scanning a target object, and that may consist of image data or time-series image data. In such a case, the source data may be the image data, and the perturbed data may be modified image data generated from the image data through perturbation.

In a preferred embodiment, the perturbation may be a random perturbation.

In another embodiment, the perturbation may be based on a predefined method.

In yet another embodiment, the perturbation may be a hybrid of both random perturbation and predefined perturbation.

In one embodiment, the first device may be a medical device for imaging a biological object, and the image data may be biological image data. For example, the medical device may be an X-ray device, a CT device, an ultrasound imaging device, or an MRI scanner.

Any device that is capable of generating and providing an image of a target object may be regarded as the first device in the context of the present invention. For example, certain types of radar devices may output images constructed in the form of contours of the detected object, and such radar devices may also be considered as the first device.

The image data or video data of the source domain may be an image or video that varies depending on the imaging device. For instance, in the case of images captured using analog or digital methods, the results for the same subject may differ depending on the type of camera, type of lens, type of digital image sensor, or type of film used. The image acquisition device may include, for example, an optical camera, X-ray camera, MR image scanner, CT scanner, radar-based scanner, or any device capable of generating images.

The image data or video data of the source domain may be an image or video that varies depending on the acquisition environment. For example, even if captured by the same device, differences may occur in the results depending on lighting conditions or light quality.

The image data or video data of the source domain may be an image or video that varies depending on the post-processing method. For example, even if the same device is used under the same acquisition environment, differences in the final processed image or video may arise depending on whether image filtering is applied.

Each perturbation for the source data 10 may be executed by the perturbation unit 1.

In one embodiment, the perturbation may be a random perturbation. Random perturbation may refer to probabilistically altering at least some values that constitute the source data 10. For example, when the source data are image data, the perturbation may include operations such as contrast adjustment, blurring, or noise addition applied to the image data. These operations may be performed on at least a portion of the pixels constituting the image data.

Alternatively, the software algorithm executed by the perturbation unit 1 for the perturbation may include image filtering algorithms such as Gaussian filters or high-pass filters.

Alternatively, the software algorithm may include image processing algorithms such as pixel distribution transformation techniques.

Alternatively, the software algorithm may include algorithms that utilize AI or machine learning models, such as generative AI models.

Hereinafter, for convenience of explanation, it is assumed that the value of K×Q shown in FIG. 2A is N.

The target model 2 may be configured to output N output data 30 by transforming each of the N perturbed data 20. The target model 2 may be designed to accept input data having the same format as the perturbed data 20.

For example, as illustrated in FIG. 2A, Q perturbed data 20 are generated from a single source data 10, and Q output data are generated from the Q perturbed data 20. Therefore, from K source data 10, a total of K×Q=N output data are generated.

In one embodiment, the target model 2 may be a data transformation module optimized for a predetermined target domain. The target domain may be defined by image data generated by a predetermined second device scanning a predetermined target object. The output data 30 may have the format intended for output by the target model 2. That is, the target model 2 may be designed to output data in that format.

For instance, if the target model 2 is configured to receive one perturbed data 20 and output an image, the output data 30 may be in the form of image data. In contrast, if the target model 2 is configured to receive one perturbed data 20 and output a scalar, vector, matrix, or tensor distinct from an image, the output data 30 may be such a scalar, vector, matrix, or tensor.

To aid understanding of the invention, in one exemplary embodiment, the second device may be a second MRI scanner, and the target model 2 may be a functional module that receives an image generated by the second MRI scanner and outputs a transformed image in which one or more image attributes of the input image are modified. The image attributes may include one or more of: image size, resolution, perspective transform, distortion, warp transform, brightness/contrast, levels, curves, saturation, hue shift, color balance, blur, sharpening, noise, distortion filters, opacity, gradient fill, and texture mapping. These examples of image attributes are provided merely to facilitate understanding of the invention, and are not intended to limit the scope of the invention.

In another exemplary embodiment provided to aid understanding of the present invention, the second device may be a second MRI scanner, and the target model 2 may be a functional module that receives an image generated by the second MRI scanner and outputs information related to a predefined region of a specific target within the input image. For example, the specific target may be a particular lesion included in the input image. In this case, the information about the region of the specific target may be a sub-image consisting only of the lesion, or metadata describing the lesion. The metadata may include, for example, the type, size, and location of the specific lesion. Such metadata may be provided in the format of a scalar, vector, or matrix as described above.

In one embodiment, the first device described in relation to the source domain and the second device described in relation to the target domain may be of the same type.

For example, the first device may be a first MRI scanner manufactured by a first manufacturer, and the second device may be a second MRI scanner manufactured by a second manufacturer. In such a case, both the first and second MRI scanners may be designed to output MR images of the same type for the same target subject. However, due to physical differences in components or differences in computing algorithms used by the devices, the characteristics of the MR images output by the two devices may differ.

Alternatively, the first device may be a first MRI scanner manufactured by a first manufacturer, and the second device may be a second MRI scanner manufactured by the same manufacturer. In this case, the first and second MRI scanners may be of the same model. However, if the manufacturing process cannot be perfectly controlled, physical variations in the components may arise, which may in turn lead to differences in the characteristics of the MR images output by the two devices.

In one embodiment of the present invention, the target model 2 may include parameters that are involved in the transformation between input and output. These parameters may be determined by human intelligence (HI) or artificial intelligence (AI). In such a case, the target model 2 or the parameters may be optimized for processing MR images output by the second device. For example, if the target model 2 includes a trained neural network, the weights constituting the neural network may represent the parameters, and such weights may be optimized for processing MR images output by the second device.

As will be further described below, the present invention is particularly advantageous in situations where the input-output relationship of the target model 2 cannot be modified. In other words, the present invention provides benefits even when the internal structure of the target model 2 is unknown. Reflecting this point, the present specification may refer to the target model 2 as a black-box model 2. For example, if the target model 2 includes a neural network developed by a developer with access to the target domain, and if the training method of the neural network is kept confidential, other developers or users may treat the target model 2 as a black-box model.

In a preferred embodiment, the target domain may be different from the source domain. However, the present invention may also be implemented even when the target domain is the same as the source domain. Nonetheless, the advantageous effects of the present invention may be more significant when the target domain differs from the source domain.

As described above, K source data 10 are transformed into N(=K×Q) perturbed data 20, and the N perturbed data 20 are then transformed into N output data 30.

In one embodiment of the present invention, only a subset of the N perturbed data 20 may be selected and used, while the remaining perturbed data may be discarded. That is, only P perturbed data 20 may be selected for use, and the remaining N-P perturbed data 20 may be discarded.

In one embodiment, in order to select certain perturbed data 20, label data 40 corresponding to each source data 10 may be utilized. That is, for each source data 10, one label data 40 may be pre-prepared. Therefore, a total of K label data 40 may be prepared for the K source data 10 and used accordingly.

For example, the label data corresponding to the k^{th} source data 10 may be the k^{th} label data 40 (k=1, . . . , K). The k^{th} label data 40 may be data that the target model 2 is expected to output when the k^{th} source data 10 is input.

To aid understanding, it may be assumed that the k^{th} source data 10 is an MR image of a patient. In this case, it may be assumed that when the k^{th} source data 10 is input into the target model 2, the model is configured to output the location coordinates of a specific lesion included in the image. In such a case, the k^{th} label data 40 may be the accurate location coordinates of the specific lesion included in the k^{th} source data 10. The accurate location coordinates of the specific lesion may be, for example, coordinates determined by a specialist who reviewed the k^{th} source data 10.

As described above, the K source data 10 belong to the source domain, and the target model 2 is a data transformation module optimized for a predetermined target domain. It is therefore reiterated that the target domain may differ from the source domain.

In this context, when the k^{th} source data 10 is perturbed once to obtain the k₁^{th} perturbed data 20, it is possible that, due to the effect of the perturbation, the k₁^{th} perturbed data 20 is closer to the feature space distribution of the target domain than the original k^{th} source data 10. If the k₁^{th} perturbed data 20 becomes closer to the feature space distribution of the target domain as a result of perturbation, then the target model 2 is likely to perform more effectively when provided with the k₁^{th} perturbed data 20 than when provided with the k^{th} source data 10.

Accordingly, if the output data generated by the target model 2 when the k^{th} source data 10 is input is referred to as the reference output data, and the output data generated by the target model 2 when the k₁^{th} perturbed data 20 is input is referred to as the k₁^{th} output data, then the error eₖ₁ between the k₁^{th} output data and the k^{th} label data 40 will be smaller than the error eₖ between the reference output data and the k^{th} label data 40.

In other words, in this case, the k₁^{th} perturbed data 20 may be regarded as having become more aligned with the characteristics of the target domain due to the effect of perturbation.

In contrast, if the k^{th} source data 10 is perturbed again to obtain k₂^{th} perturbed data 20, it is also possible that the k₂^{th} perturbed data 20 becomes farther from the feature space distribution of the target domain than the original k^{th} source data 10, due to the effect of the perturbation. If the k₂^{th} perturbed data 20 becomes farther from the target domain's feature distribution compared to the k^{th} source data 10, the target model 2 is likely to perform less effectively when receiving the k₂^{th} perturbed data 20 than when receiving the original k^{th} source data 10.

Accordingly, if the output data generated by the target model 2 upon input of the k^{th} source data 10 is referred to as the reference output data, and the output data generated by the target model 2 upon input of the k₂^{th} perturbed data 20 is referred to as the k₂^{th} output data, then the error eₖ₂ between the k₂^{th} output data and the k^{th} label data 40 is likely to be greater than the error eₖ between the reference output data and the k^{th} label data 40. In other words, in this case, due to the effect of the perturbation, the k₂^{th} perturbed data 20 may have characteristics that are farther from the target domain.

Therefore, in one embodiment, the k^{th} source data 10 may be perturbed to generate k^{th} perturbed data 20, and the k^{th} perturbed data 20 may then be input into the target model 2 to generate k^{th} output data 30. If the error between the k^{th} output data 30 and the k^{th} label data 40 is less than or equal to a predetermined threshold value, then the k^{th} perturbed data 20 may be selected for use. Conversely, if the error between the k^{th} output data 30 and the k^{th} label data 40 exceeds the predetermined threshold value, then the k^{th} perturbed data 20 may be discarded (k=1, . . . , N).

The threshold value may be a fixed value that is preconfigured, or alternatively, it may be determined dynamically based on the N errors computed from the N output data 30, by, for example, selecting a number of smallest errors after sorting them in descending order. That is, the method for determining the threshold value is not necessarily limited to any specific approach.

In other words, the errors associated with the selected perturbed data 20 among the N perturbed data 20 may all be smaller than the errors associated with the discarded perturbed data 20.

Hereinafter, the above-described content will be illustrated with reference to FIG. 2B.

As shown in the first block from the top in FIG. 2B, the data selection unit 3 may calculate respective errors (e₁₁, e₁₂, . . . , e_{1Q}) between Q output data 30 generated from first source data 10 and the first label data 40 provided for the first source data 10. In this case, the first source data 10 is represented by a circular icon including the reference number “1” and the first label data 40 is represented by a rectangular icon including the reference number “1”

As shown in the second block from the top in FIG. 2B, the data selection unit 3 may calculate respective errors (e₂₁, e₂₂, . . . , e_{2Q}) between Q output data 30 generated from second source data 10 and the second label data 40 provided for the second source data 10. Here, the second source data 10 is represented by a circular icon including the reference number “2” and the second label data 40 is represented by a rectangular icon including the reference number “2”

As shown in the last block from the top in FIG. 2B, the data selection unit 3 may calculate respective errors (e_{K1}, e_{K2}, . . . , e_{KQ}) between Q output data 30 generated from K^{th} source data 10 and the K^{th} label data 40 provided for the K^{th} source data 10. The K^{th} source data 10 is represented by a circular icon including the reference number “K” and the K^{th} label data 40 is represented by a rectangular icon including the reference number “K”

In this case, among the aforementioned errors (e₁₁, e₁₂, . . . , e_{1Q}), (e₂₁, e₂₂, . . . , e_{2Q}), and (e_{K1}, e_{K2}, . . . , e_{KQ}), it is assumed that the errors e₁₁, e₂₁, e₂₂, and e_{K2} are less than a predetermined threshold value, while all other errors are greater than the threshold.

Accordingly, the perturbed data 20 corresponding to the errors e₁₁, e₂₁, e₂₂, and e_{K2} may be selected for use, and the remaining perturbed data may be discarded.

The selected perturbed data may be referred to in this specification as pseudo-target data and may be denoted by reference number 50.

In this case, each pseudo-target data 50 may be paired with one source data 10 used to generate it. In the example of FIG. 2B, it can be seen that the pseudo-target data 50 denoted by reference numbers 11, 21, 22, and K2 are respectively paired with the first source data 10, the second source data 10, the second source data 10 again, and the K^{th} source data.

Hereinafter, in this specification, the source data 10 that are paired with the pseudo-target data 50 may be referred to using the reference number 10p.

FIG. 3 is a diagram illustrating training data composed of pairs of the determined pseudo-target data 50 and the respective paired source data. The training data are used for the first-stage training method. When each source data 10p is input into the harmonization network 4, the harmonization network 4 may generate corresponding output data. The training controller 5 may use the pseudo-target data 50 paired with the source data 10p as training labels. That is, the training controller 5 may update the configuration of the harmonization network 4 so as to reduce the error between the pseudo-target data 50 and the output data.

With reference to FIGS. 1A, 1B, 2A, 2B, and 3, the concept of the present invention illustrated above will now be further generalized and described below.

Hereinafter, in this specification, it is assumed that P perturbed data 20 are selected out of N perturbed data 20, and the remaining N-P perturbed data 20 are discarded, where P is a natural number between 1 and N inclusive. In this case, although the selected P perturbed data 20 do not belong to the target domain, they may be regarded as being closer to the feature space distribution of the target domain. Therefore, the selected P perturbed data 20 may be referred to as pseudo-target data 50 in this specification.

In one embodiment, each of the pseudo-target data 50 may be image data representing an image.

In this case, among the K source data 10, there exist source data 10 corresponding to the P pseudo-target data 50.

Two different pseudo-target data 50 out of the P pseudo-target data 50 may originate from the same source data 10, or from different source data 10.

For example, in an extreme case, all of the selected P pseudo-target data 50 may have been generated from a single one of the K source data 10.

Alternatively, each of the P pseudo-target data 50 may have been generated from a different one of the P source data 10 (in which case, P is less than or equal to K).

Regardless of the case, for each selected pseudo-target data 50, the source data 10 used to generate the corresponding pseudo-target data 50 can be identified and paired with it. Accordingly, when P pseudo-target data 50 are given, P pairs of data consisting of each pseudo-target data and its corresponding source data may be formed.

In this context, it is understood that the P pseudo-target data 50 are obtained as a result of perturbing (e.g., randomly perturbing) at least a portion of the K source data 10 using the perturbation unit 1. Therefore, even if the same source data 10 are input again into the perturbation unit 1, it cannot be expected that the exact same P pseudo-target data 50 will be generated.

Now, in one embodiment of the present invention, the trainable harmonization network 4 is defined. The harmonization network 4 may be designed to receive input data having the same format as the source data 10 and to output data having the same format as the perturbed data 20.

Next, when the p^{th} source data 10 paired with the p^{th} pseudo-target data 50 among the selected P pseudo-target data 50 is input into the harmonization network 4, instead of the perturbation unit 1, the harmonization network 4 may be trained in a supervised manner such that the error between the output generated by the harmonization network 4 and the p^{th} pseudo-target data 50 is reduced.

When P pseudo-target data 50 are prepared, it can be understood that the training of the harmonization network 4 may be iterated P times.

By training the harmonization network 4 in the above-described manner, a harmonization network 4 can be generated that operates in a deterministic manner using a subset of results that were previously generated by the perturbation unit 1 through random transformation.

As a result, when arbitrary first source data 10 are input into the trained harmonization network 4, the harmonization network 4 may output corresponding first pseudo-target data 50. The first pseudo-target data 50 thus generated may be considered as having characteristics that belong to or are close to the feature space distribution of the target domain.

When the outputted first pseudo-target data 50 are input into the target model 2, the target model 2 may generate corresponding first output data. It can be expected that the error between the label data corresponding to the first source data 10 and the generated first output data will be very small. This is because the trained harmonization network 4 transforms arbitrary source data 10 from the source domain into pseudo-target data 50 that are closer to the feature space distribution of the target domain.

Accordingly, the result produced by the target model 2 when the first pseudo-target data 50 are input may be considered to have higher reliability than the result produced by the target model 2 when the first source data 10 are directly input.

### Second-Stage Training of the Harmonization Network

Upon completion of the first-stage training process of the harmonization network described above, the training of the harmonization network may be considered complete. Thereafter, the present invention may provide a second-stage training process in which the trained harmonization network is further trained using a different training method.

FIG. 4 is a diagram illustrating a framework for the second-stage training of the harmonization network training method according to an embodiment of the present invention.

The harmonization network 4 illustrated in FIG. 4 has undergone the training process described in the first-stage training. The target model 2 shown in FIG. 4 is the same as the target model 2 used in the first-stage training. The training controller 5 shown in FIG. 4 may be the same as, or different from, the training controller presented in FIG. 1A and FIG. 1B.

The method for second-stage training may be executed by a computing device reading and executing a program including a set of instructions from memory. The set of instructions may include: a second set of instructions for implementing the functionality of the target model 2, a fourth set of instructions for implementing the functionality of the harmonization network 4 as corrected through the first-stage training, a fifth set of instructions for implementing the functionality of the training controller 5, which trains the harmonization network 4, and a sixth set of instructions for scheduling the execution of the above instruction sets.

The fifth set of instructions implementing the functionality of the training controller 5 may include both the instructions used in the first-stage training and those used in the second-stage training.

The second-stage training process may include a second training step of additionally training the harmonization network 4 using a second set of source data 60 belonging to the source domain and a second set of label data 90 corresponding to the second set of source data 60.

The second set of source data 60 may include at least part of the source data 10 used in the first-stage training, or it may include none of the source data 10.

The second training step may specifically include the following steps:

First, a step of inputting a first source data 60 from the second set into the harmonization network 4 to output corresponding first harmonized data 70 from the harmonization network 4.

Next, a step of inputting the first harmonized data 70 into the target model 2 to output first output data 80 corresponding to the first harmonized data 70.

Then, a step of training the harmonization network 4, by the training controller 5, to reduce the error between the first label data 90 corresponding to the first source data 60 and the first output data 80.

Alternatively, the second training step may be described again as including the following steps.

First, a step of inputting the second set of source data 60 belonging to the source domain into the harmonization network 4 to output the second set of harmonized data 70.

Next, a step of inputting the second set of harmonized data 70 into the target model 2 to output the second set of output data 80.

Then, a step of training the harmonization network 4, by the training controller 5, to reduce the error between the second set of label data 90 corresponding to the second set of source data 60 and the second set of output data 80.

Once the second-stage training is completed, the performance of the harmonization network 4, which was previously trained through the first-stage training, may be further improved. That is, when arbitrary source data belonging to the source domain are input into the harmonization network 4, the harmonized data output by the harmonization network 4 may become more closely aligned with the feature space distribution of the target domain, which is used in the design of the target model.

### Embodiment of First-Stage Training of the Harmonization Network

Hereinafter, to aid understanding of the present invention, an embodiment of the first-stage training of the harmonization network described above will be explained with reference to drawings that include specific data.

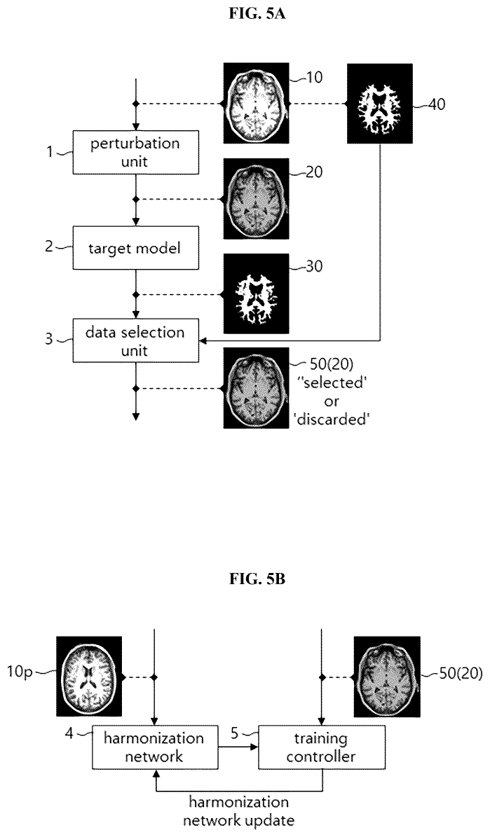

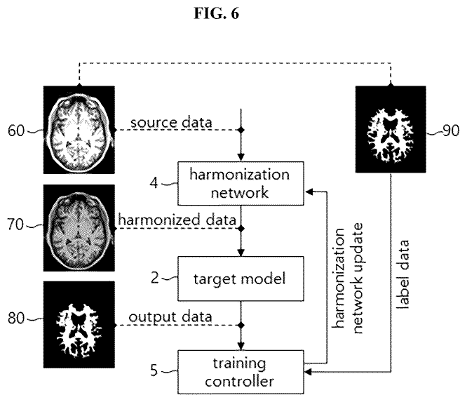

FIG. 5A and FIG. 5B are reconstructed version of the framework shown in FIG. 1A and FIG. 1B, based on the case where the source data 10, perturbed data 20, output data 30, label data 40, and pseudo-target data 50 are all in the form of images.

In this example, the source data 10 are source images 10 representing MR images of the brain.

The perturbed data 20 are perturbed images 20 obtained by perturbing the source images 10 using the perturbation unit 1.

The output data 30 are output images 30 generated by the target model 2 by transforming the perturbed images 20.

The target model 2 may be a functional module designed to generate and output images that are as similar as possible to a label image 40 of the brain MR image, when it receives the source image 10 as input. The label image 40 is not an image generated by the target model 2, but rather a ground truth image related to the MR image, obtained using a different operating mode of the MRI scanner or a different type of scanner altogether.

As shown in FIG. 5A, when the error between the output image 30 generated from the source image 10 and the label image 40 is below a threshold, the data selection unit 3 may select the perturbed image 20 generated from the source image 10 as pseudo-target image 50, which can then be used to train the harmonization network 4.

As shown in FIG. 5B, the harmonization network 4 may be trained in a supervised manner using the selected pseudo-target image 50 and the corresponding paired source image 10.

### Embodiment of Second-Stage Training of the Harmonization Network

Hereinafter, to aid understanding of the present invention, an embodiment of the second-stage training of the harmonization network described above will be explained with reference to a drawing that includes specific data.

FIG. 6 is a reconstructed version of the framework shown in FIG. 4, based on the case where the source data 60, harmonized data 70, output data 80, and label data 90 are all in the form of images.

In this example, the source data 60 are source images 60 representing MR images of the brain.

The harmonized data 70 are harmonized images 70 obtained by transforming the source images 60 using the harmonization network 4.

The output data 80 are output images 80 generated by the target model 2 by transforming the harmonized images 70.

The label images 90 may be ground truth images related to the source images 60, obtained using a different operating mode of the MRI scanner or using a different type of scanner.

### Embodiment: First Combined Method of First-Stage and Second-Stage Training of the Harmonization Network

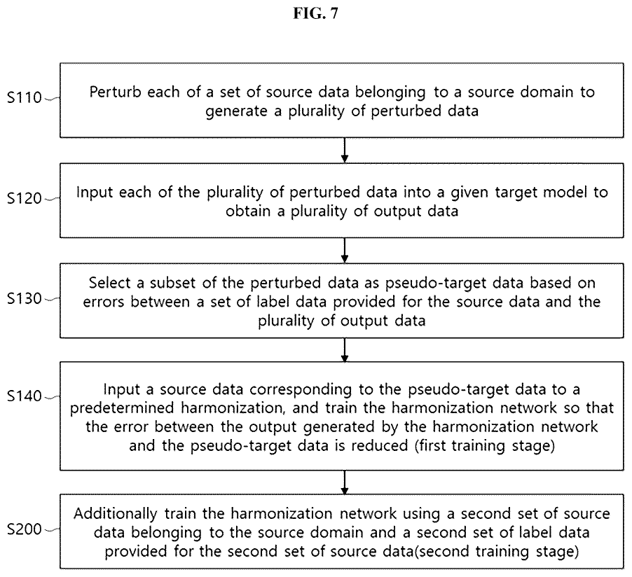

FIG. 7 is a flowchart illustrating a harmonization network training method according to an embodiment of the present invention.

In step S110, a computing device may perturb each of a set of source data 10 belonging to a source domain to generate a plurality of perturbed data 20.

In one embodiment, the set of source data 10 may consist of K source images, and the plurality of perturbed data 20 may consist of N perturbed images, where K and N are natural numbers.

In step S120, the computing device may input each of the plurality of perturbed data 20 into a given target model 2 to obtain a plurality of output data 30.

The plurality of output data 30 may consist of N output data. Each of the output data 30 may correspond to a respective one of the perturbed data 20.

In step S130, the computing device may select, as pseudo-target data 50, a subset of the perturbed data 20 based on the errors between a set of label data 40 provided for the source data 10 and the plurality of output data 30.

In step S140, the computing device may train a harmonization network 4 such that the error between the output generated by the harmonization network 4 and the pseudo-target data 50 is reduced when the source data 10 corresponding to the pseudo-target data 50 are input into the harmonization network 4.

In step S200, the computing device may further train the harmonization network 4 using a second set of source data 60 belonging to the source domain and a second set of label data 90 provided for the second set of source data 60.

Here, steps S110, S120, S130, and S140 may collectively be referred to as a first training stage.

Alternatively, steps S110, S120, and S130 may be collectively referred to as a training data preparation stage, and step S140 may be referred to as the first training stage.

Step S200 may be referred to as the second training stage.

### Embodiment: Flowchart of the Second Training Stage

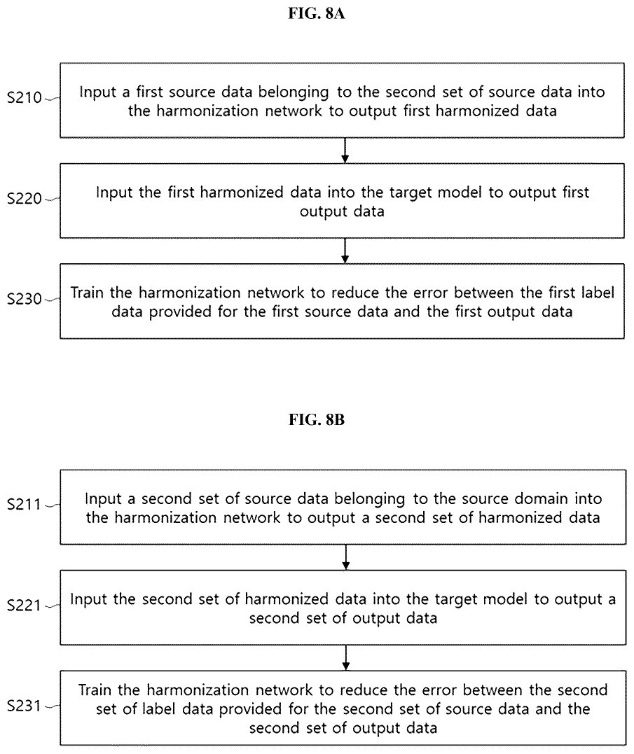

FIG. 8A is a flowchart illustrating sub-steps constituting the second training stage according to an embodiment of the present invention.

The second training stage may include the following steps: step S210, step S220, and step S230.

In step S210, the computing device may input a first source data 60, which belongs to the second set of source data 60, into the harmonization network 4 to output first harmonized data 70.

In step S220, the computing device may input the first harmonized data 70 into the target model 2 to output first output data 80.

In step S230, the computing device may train the harmonization network 4 so as to reduce the error between the first label data 90, which is provided for the first source data 60, and the first output data 80.

FIG. 8B is a flowchart illustrating sub-steps constituting the second training stage according to another embodiment of the present invention.

The second training stage may include the following steps: step S211, step S221, and step S231.

In step S211, the computing device may input the second set of source data 60 belonging to the source domain into the harmonization network 4 to output the second set of harmonized data 70.

In step S221, the computing device may input the second set of harmonized data 70 into the target model 2 to output the second set of output data 80.

In step S231, the computing device may train the harmonization network 4 so as to reduce the error between the second set of label data 90, which is provided for the second set of source data 60, and the second set of output data 80.

It should be understood that the configuration of the flowchart shown in FIG. 8B is substantially the same as the configuration shown in FIG. 8A, although the manner of presentation differs.

### Embodiment: Second Combined Method of First-Stage and Second-Stage Training of the Harmonization Network

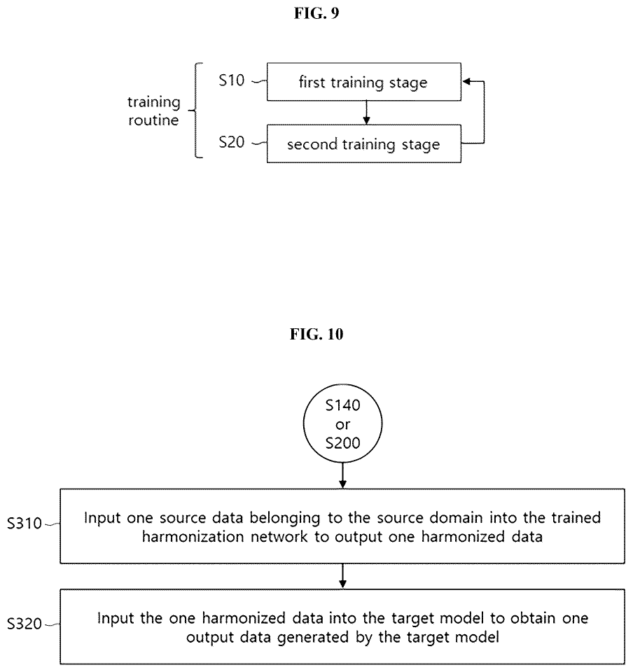

FIG. 9 is a flowchart illustrating a harmonization network training method according to another embodiment of the present invention.

Referring again to FIG. 7, one example is presented in which the second-stage training is performed only after the completion of the first-stage training. In such a case, the training of the harmonization network may be terminated without re-executing the first-stage training after completing the second-stage training. The first-stage training corresponds to the method described with reference to FIG. 5A and FIG. 5B, and the second-stage training corresponds to the method described with reference to FIG. 6.

In contrast, in the modified embodiment illustrated in FIG. 9, the first-stage training (S10) and second-stage training (S20) may be alternately executed. The first-stage training (S10) and the second-stage training (S20) may be executed independently of one another. However, in a preferred embodiment, at least one instance of the first-stage training (S10) may be performed before the first instance of the second-stage training (S20) is executed.

In FIG. 9, one training routine consists of one instance of the first-stage training (S10) followed by one instance of the second-stage training (S20). This training routine may be repeated K times, where K is a natural number.

In this case, in the k^{th} training routine, the number of source data included in the set used for the first-stage training (S10) may be denoted by N_{k,1}, and the number of source data included in the set used for the second-stage training (S20) may be denoted by N_{k,2} (where k=1, . . . , K). The value of N_{k,1} may be arbitrarily selected as a first natural number equal to or greater than 1, and the value of N_{k,2} may be arbitrarily selected as a second natural number equal to or greater than 1. The selection of N_{k,1} and N_{k,2} may be made independently of each other. Furthermore, the values of N_{k,1} may be independently selected for different values of k, and likewise, the values of N_{k,2} may also be independently selected for different values of k.

If the training routine is repeated K times, the first-stage training (S10) is executed K times in total, and the second-stage training (S20) is also executed K times in total. The source data used in each of the first-stage training (S10) and the second-stage training (S20) may be entirely different, or some or all of the same source data may be reused. That is, the source data used in the first-stage training (S10) and second-stage training (S20) may or may not be reused during the training process.

In one embodiment, the training of the harmonization network may be terminated after the training routine is repeated K times.

In another embodiment, after repeating the training routine K times, the first-stage training may be performed once more before terminating the training of the harmonization network.

The harmonization network training method shown in FIG. 7 may be interpreted as a special case of the training method shown in FIG. 9. Specifically, the case where the training routine of FIG. 9 is executed only once, i.e., where K=1, corresponds to the method of FIG. 7. In this case, it is preferable that the number of source data used in the first-stage training and the number of source data used in the second-stage training are both greater than one.

### Method of Using the Trained Harmonization Network

The functionality of the target model 2 can be fully utilized by employing the harmonization network 4 trained through step S140 and/or the harmonization network 4 trained through step S200.

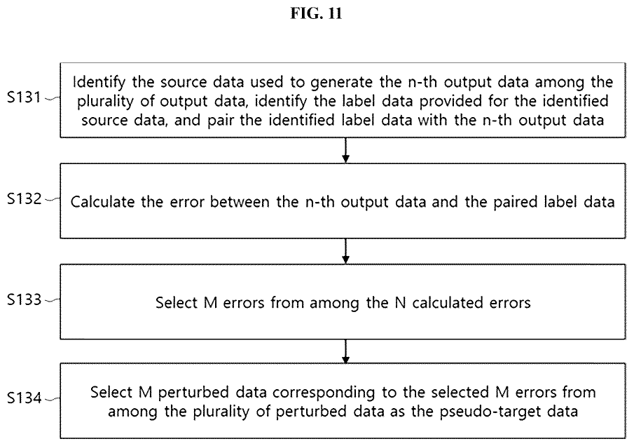

FIG. 10 is a flowchart illustrating a method of using the target model 2 by employing a trained harmonization network, according to an embodiment of the present invention.

Step S310 may be executed after step S140 or after step S200. In other words, step S310 may be executed after the harmonization network has been trained through the above-described first-stage and/or second-stage training.

In step S310, the computing device may input one source data belonging to the source domain into the trained harmonization network to output one harmonized data.

In step S320, the computing device may input the harmonized data into the target model and obtain one output data generated by the target model.

### Embodiment—Method for Selecting Pseudo-Target Data

FIG. 11 is a flowchart providing a more detailed illustration of the step for selecting pseudo-target data as presented in FIG. 7.

The step S130 of selecting pseudo-target data in FIG. 7 may include the following sub-steps:

In step S131, the computing device may identify the source data used to generate the n^{th} output data 30 among the plurality of output data 30, and may also identify the label data 40 provided for the identified source data so as to pair the identified label data 40 with the n^{th} output data 30. Here, n=1, . . . , N, where N represents the total number of output data.

In step S132, the computing device may calculate the error between the n^{th} output data and its paired label data (for n=1, . . . , N).

In step S133, the computing device may select M errors from among the calculated N errors. Here, M may be a natural number less than N.

In step S134, the computing device may select, as pseudo-target data 50, M perturbed data from among the plurality of perturbed data that correspond to the M selected errors.

The target model may be a model trained using data belonging to the target domain, and the source domain and the target domain may be different domains.

The data belonging to the source domain may be generated by a first electronic device, and the data belonging to the target domain may be generated by a second electronic device. The first and second electronic devices may be different devices.

The first electronic device may be a first MRI scanner, and the second electronic device may be a second MRI scanner.

Alternatively, the first electronic device may be a first X-ray device, and the second electronic device may be a second X-ray device.

Alternatively, the first electronic device may be a first CT device, and the second electronic device may be a second CT device.

Each of the harmonized data, source data, perturbed data, and input data may be in the form of image data.

The maximum value among the M selected errors may be less than or equal to the minimum value among the (N-M) unselected errors.

The source data may be in the form of image data.

The perturbation may include one or more of contrast adjustment, blurring, and noise addition applied to the source data.

The source data may be MR images or X-ray images.

The label data and the output data may both be in the form of image data.

Alternatively, the label data and the output data may both be in a format different from image data.

The target model may be a model in which the transformation relationship between input and output cannot be altered.

### Embodiment: Computing Device for Executing the Method of the Present Invention

Each of the steps described in FIGS. 7 through 11 may be executed by a computing device by reading and executing a program including a set of instructions stored in a non-transitory storage medium accessible by the computing device.

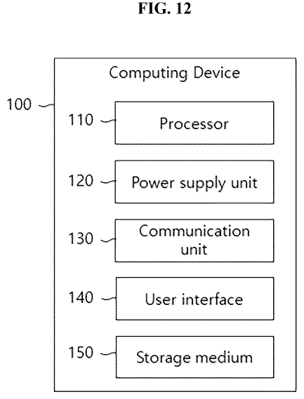

FIG. 12 is a diagram illustrating a computing device according to an embodiment of the present invention.

The computing device 100 may include a processor 110, a power supply unit 120, a communication unit 130, a user interface 140, and a storage medium 150.

The processor 110 may include one or more of a CPU (Central Processing Unit), an AP (Application Processor), a DSP (Digital Signal Processor), an FPGA (Field Programmable Gate Array), an ASIC (Application-Specific Integrated Circuit), an MCU (Microcontroller Unit), or an SoC (System on Chip).

The storage medium 150 may include one or more of an HDD (Hard Disk Drive), an SSD (Solid State Drive), an NVMe SSD (Non-Volatile Memory Express SSD), an eMMC (embedded MultiMediaCard), a UFS (Universal Flash Storage), a RAM (Random Access Memory), a DRAM (Dynamic RAM), an SRAM (Static RAM), NAND Flash, NOR Flash, 3D NAND, ReRAM (Resistive RAM), MRAM (Magnetoresistive RAM), PRAM (Phase-Change RAM), an SD Card (Secure Digital Card), a USB Flash Drive, a CF Card (Compact Flash), a NAS (Network-Attached Storage), or a RAID (Redundant Array of Independent Disks).

The instruction codes for executing the respective steps described in this specification may be stored in the storage medium 150, and the processor 110 may read and execute the instruction codes.

As used in this specification, the term “perturbation” should be understood to include not only “random perturbation” but also other types of perturbations that are not random in nature.

It can be understood from the foregoing description that the present invention may be applied not only in situations where the input-output relationship of the target model 2 cannot be further manipulated, but also in cases where the identity of the target domain used to train the target model 2 is unknown.

Using the embodiments described above, those skilled in the art to which the present invention pertains will be able to implement various modifications and changes without departing from the essential characteristics of the present invention. The subject matter of each claim in the appended claims may be combined with another claim that is not referenced therein, within the scope of understanding provided by this specification.

### ACKNOWLEDGEMENT

This invention was supported by the National R&D Program of Korea, specifically under Project Number RS-2024-00435727 (Unique Identifier: 2340011700), funded by the Ministry of Education and administered by the National Research Foundation of Korea (NRF) as part of the Basic Science Research Capability Enhancement Program, titled “Infrastructure Advancement: Solving Difficult Problems in Brain Structure and Function through the Introduction of a High-Angle Diffusion Magnetic Resonance Imaging Device,” and carried out by Seoul National University during the research period from Jun. 1, 2024, to Feb. 28, 2027.

This invention was also supported by the National R&D Program of Korea, specifically under Project Number RS-2024-00349509 (Unique Identifier: 2710005119), funded by the Ministry of Science and ICT and administered by the National Research Foundation of Korea (NRF) as part of the Basic Research Program for Individual Researchers, for the research project titled “Development and Application of Susceptibility-Based Microstructure Brain Imaging,” conducted by the Seoul National University Research & Business Foundation during the research period from May 1, 2024, to Apr. 30, 2028.

This invention was further supported by the National R&D Program of Korea, specifically under Project Number RS-2024-00439677 (Unique Identifier: 2460001701), funded by the Ministry of Health and Welfare and administered by the Korea Health Industry Development Institute (KHIDI) as part of the Hospital-based Biomedical Research Program, for the research project titled “Development of Ultra-Scale Time-Series Multimodal AI Agents and Clinical Validation via a Multinational Monitoring Platform,” conducted by Seoul National University Hospital during the research period from Jul. 1, 2024, to Dec. 31, 2026.

What is claimed is:

1. A method for training a harmonization network, the method comprising:
generating, by a computing device, a plurality of perturbed data by perturbing each of a set of source data belonging to a source domain;
obtaining, by the computing device, a plurality of output data by inputting each of the plurality of perturbed data into a given target model;
selecting, by the computing device, a subset of the plurality of perturbed data as pseudo-target data based on errors between a set of label data provided for the set of source data and the plurality of output data; and
training, by the computing device, a harmonization network such that, when source data corresponding to the pseudo-target data are input into the harmonization network, an error between output data generated by the harmonization network and the pseudo-target data is reduced.

2. The method of claim 1, further comprising:
additionally training, by the computing device, the harmonization network after the training, by using a second set of source data belonging to the source domain and a second set of label data provided for the second set of source data.

3. The method of claim 2, wherein the second training step comprises:
generating, by the computing device, first harmonized data 70 by inputting a first source data, which belongs to the second set of source data, into the harmonization network;
generating, by the computing device, first output data by inputting the first harmonized data 70 into the target model 2; and
training, by the computing device, the harmonization network 4 by reducing an error between first label data 90, which is provided for the first source data 60, and the first output data 80.

4. The method of claim 1, further comprising:
generating, by the computing device, harmonized data by inputting a source datum belonging to the source domain into the trained harmonization network; and
obtaining, by the computing device, output data by inputting the harmonized data into the target model.

5. The method of claim 1, wherein the target model is a model trained using data belonging to a target domain, and the source domain and the target domain are different domains.

6. The method of claim 4, wherein data belonging to the source domain is data generated by a first electronic device, data belonging to the target domain is data generated by a second electronic device, and the first electronic device and the second electronic device are different devices.

7. The method of claim 1, wherein each of the harmonized data, the source data, the perturbed data, and the input data is in the form of image data.

8. The method of claim 1, wherein the selecting comprises:
identifying, by the computing device, a source datum used to generate an n^{th} output data 30 among the plurality of output data 30, and identifying label data 40 provided for the identified source datum, thereby pairing the identified label data 40 with the n^{th} output data 30, where n=1, . . . , N and N is a total number of the output data;
calculating, by the computing device, an error between each of the n^{th} output data and its paired label data (for n=1, . . . , and N);
selecting, by the computing device, M errors from among the N calculated errors, where M is a natural number less than N; and
selecting, by the computing device, M perturbed data from among the plurality of perturbed data as the pseudo-target data 50, the M perturbed data corresponding to the selected M errors.

9. The method of claim 7, wherein an algorithm executed by the computing device for the perturbation comprises at least one of:
an algorithm that performs one or more of contrast adjustment, blurring, and noise addition on the source data;
an image filtering algorithm;
an image processing algorithm; and
an algorithm utilizing an AI model.

10. The method of claim 1, wherein:
both the label data and the output data are in the form of image data; or
both the label data and the output data are in a format other than image data.

11. The method of claim 1, wherein:
the target model is such that a transformation relationship between an input and an output of the target model cannot be modified by the computing device; or
the target model is such that a transformation relationship between an input and an output of the target model can be modified by the computing device.

12. The method of claim 1,
wherein at least one of the harmonized data, the source data, the perturbed data, and the input data is image data,
and the image data is:
image data that varies depending on an image acquisition device used to generate the image data;
image data that varies depending on an acquisition environment in which the image data is obtained; or
image data that varies depending on a post-processing method performed to generate the image data.

13. A method for training a harmonization network, the method comprising a first training stage comprising:
generating, by a computing device, N perturbed images by perturbing each of K source images belonging to a source domain, wherein K and N are natural numbers;
obtaining, by the computing device, N output data by inputting each of the N perturbed images into a given target model, the N output data respectively corresponding to the N perturbed images;
selecting, by the computing device, a subset of the N perturbed images as pseudo-target images based on errors between K label data, each of which is pre-prepared and matched to a corresponding one of the K source images, and the N output data; and
training, by the computing device, a harmonization network such that, when source images corresponding to the pseudo-target images are input into the harmonization network, an error between output images generated by the harmonization network and the pseudo-target images is reduced.

14. The method of claim 13,
further comprising a second training stage performed after the first training stage, the second training stage comprising additionally training the harmonization network using a second set of source images belonging to the source domain and a second set of label images provided for the second set of source images,
the second training stage comprising:
generating, by the computing device, a first harmonized image by inputting a first source image, which belongs to the second set of source images, into the harmonization network;
inputting the first harmonized image into the target model to generate first output data corresponding to the first harmonized image; and
training the harmonization network to reduce an error between first label data provided for the first source image and the first output data,
wherein the first training stage is further executed repeatedly after the second training stage.

15. A method for training a harmonization network, the method comprising:
a second training stage of training the harmonization network; and
a first training stage of further training the harmonization network after the second training stage,
wherein the second training stage comprises:
generating, by a computing device, a first harmonized image by inputting a first source image, which belongs to a second set of source images belonging to a source domain, into the harmonization network;
generating, by the computing device, first output data corresponding to the first harmonized image by inputting the first harmonized image into a given target model; and
training, by the computing device, the harmonization network to reduce an error between first label data provided for the first source image and the first output data;
wherein the first training stage comprises:
generating, by the computing device, N perturbed images by perturbing each of K source images belonging to the source domain, where K and N are natural numbers;
obtaining, by the computing device, N output data by inputting each of the N perturbed images into the target model, the N output data respectively corresponding to the N perturbed images;
selecting, by the computing device, a subset of the N perturbed images as pseudo-target images based on errors between K label data, each of which is pre-prepared and matched to a corresponding one of the K source images, and the N output data; and
training, by the computing device, the harmonization network such that, when source images corresponding to the pseudo-target images are input into the harmonization network, an error between output images generated by the harmonization network and the pseudo-target images is reduced,
wherein the second training stage is further executed after the first training stage.
